(19) United States
(12) Patent Application Publication
(10) Pub. No.: US 2004/0185848 A1
(43) Pub. Date: Sep. 23, 2004

(54) Subscriber registrations in a mobile communication system

(76) Inventors: Son Phan-Anh, Budapest (HU); Gabor Bajko, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/476,622

(22) PCT Filed: May 3, 2002
(86) PCT No.: PCT/IB02/02657

(30) Foreign Application Priority Data
May 3, 2001 (GB) 0110900.8

(51) Int. Cl. H04Q 7/20

(52) U.S. Cl. 455/435.1; 455/435.2; 455/433

(57) ABSTRACT

A method for a communication system and a communication system is disclosed. A user (1) can be provided with at least one registration at a first control entity (22). Said at least one registration is transferred to a second control entity (23) in response to another registration of the user to said second control entity. Any of the registrations may expiry in response to expiry of a timer.

### FIELD OF THE INVENTION

The present invention relates to a communication system, and in particular, but not exclusively, to a communication system wherein a user thereof may have multiple registrations to control means.

### BACKGROUND OF THE INVENTION

A communication system can be seen as a facility that enables communication between two or more entities such as user equipment and/or other nodes associated with the system. The communication may comprise, for example, communication of voice, data, multimedia and so on.

A communication system typically operates in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems proving wireless communication for user terminals or other nodes are known. An example of the wireless systems is a cellular network. In cellular systems, a base transceiver station (BTS) or similar access entity serves mobile stations (MS) or similar user equipment (UE) via a wireless interface between these entities. The operation of the apparatus required for the communication can be controlled by one or several control entities. The various control entities may be interconnected. One or more gateway nodes may also be provided for connecting the cellular network to other networks, such as to another cellular system or to a public switched telephone network (PSTN) and/or other communication networks such as an IP (Internet Protocol) and/or other packet switched networks. The communication between the user equipment and the elements of the communication network can be based on an appropriate communication protocol such as the session initiation protocol (SIP)

For example, in the current third generation (3G) multimedia network architectures it is assumed that various servers are used for handling different functions. These include functions such as call state control functions (CSCFs). A call state control function entity may provide functions such as proxy call state control (P-CSCF), interrogating call state control (I-CSCF), and serving call state control (S-CSCF). The serving call state control function can be divided further between originating call state control function (O-CSCF) and terminating call state control function (T-CSCF) at the originating and terminating ends of a session, respectively. Control functions may also be provided by entities such as a home subscriber server (HSS) and various application servers.

From the above mentioned control entities the home subscriber server (HSS) is for storing subscriber related information. The subscriber information may include data such as registration identities (ID) of the subscriber or the terminals and so on. The home subscriber server (HSS) can be queried by other function entities, e.g. during registration and session set-up procedures. It shall be appreciated that the term “session” refers to any communication a user may have such as to a call, data (e.g. web browsing) or multimedia communication and so on.

A user in communication with an access entity of the communication system may be registered in a serving controller entity such as in a S-CSCF. During registration proceedings various authentication queries or messages and authentication parameters such as those based on authentication quintets and/or keys may be transferred between the entities involved in the process. A user may have more than one registration at the same time. The registration is required for communication via the communication system.

During a registration procedure a user identifier such as a public ID is provided for the controller entity. Public ID is an identifier of a user of the communication system and the basic function thereof corresponds a telephone number of the known telephone systems. However, while a telephone e.g. a mobile phone can only have one number, e.g. a 3G phone may have more than one identifier (e.g. a telephone number, one or more email-like addresses, for example session initiation protocol (SIP) universal resource locators (URL), an address or addresses for alternative communications means, and so on).

In order to be able to use a conventional mobile station for communication, the user must typically turn on the mobile station. In the 3G communication systems a user who wants to initiate a call or receive a call the user must register his/hers public ID. If a user has two public IDs (e.g. ID1 and ID2) and only ID1 is registered, all calls initiated to/from ID2 will be unsuccessful since ID2 has not been registered with the network.

Once a public ID is registered it is stored both in a P-CSCF and S-CSCF. An expiration timer is associated with the stored public ID. The timer functions such that when the expiration timer expires the registration of that specific public ID becomes invalid.

The current registration procedures such as those specified by the 3^{rd} generation partnership project (3GPP) register each public ID for a user separately and independently. It has been proposed that all user identifiers of a particular subscriber shall be registered in a controller entity. For example, release 5 (Rel5) version of a 3GPP standard document proposes that all those identifiers are registered in the same serving call state control function (S-CSCF) entity.

The S-CSCF entity is aware of the registration status in the level of individual public IDs. The existing registrations may need to be moved from one S-CSCF to other S-CSCF. This may occur, for example, when a S-CSCF that should be serving a subscriber fails or goes otherwise out of service and another S-CSCF must be assigned e.g. by an I-CSCF entity for incoming registration requests. A new S-CSCF may be selected e.g. by means of so called Cx-query. It is also possible that the subscriber profile has been changed in the HSS which causes changes in the required capability. The current S-CSCF may not be able to provide the required capability and thus the subscriber must be re-allocated to another S-CSCF. It shall be understood that these are only examples and that the S-CSCF re-selection may also be caused by various other reasons.

As mentioned above, in some communication standards such as, for example, in the 3GPP Rel5 based systems, all public identifiers that belong to the same IP multimedia subsystem (IMS) subscriber have to be registered to the same controller entity. However, the inventors have found that at the same time any registration, re-registration and de-registration proceeding are done on a one-by-one basis. Since the registration of individual public IDs is handled independently, only one public ID can be newly registered to a new S-CSCF or moved from an old S-CSCF to another S-CSCF. As a result of this it may happen that a certain list of public IDs of a subscriber are registered to a S-CSCF while the rest of the public IDs is registered to another S-CSCF. This may not be allowed in all applications.

It shall be appreciated that although the above discussed the registration proceedings and related problems with reference to an internet protocol (IP) based third generation (3G) communication system and session initiation protocol (SIP), similar disadvantages may associate with other systems as well and thus the description is not limited to these examples.

### SUMMARY OF THE INVENTION

Embodiments of the present invention aim to address one or several of the above problems.

According to one aspect of the present invention, there is provided a method in a communication system wherein a user is provided with at least one registration to a first control entity, comprising transferring said at least one registration to a second control entity in response to another registration of the user to said second control entity.

According to another aspect of the present invention there is provided a communication system comprising a first control entity and a second control entity, wherein at least one registration of the user at the first entity is adapted to be transferred to the second control entity in response to a registration of the user at said second control entity.

In a more detailed embodiment all registrations of the user are transferred to said second control entity. According to an alternative only predefined registrations of the user are transferred to said second control entity.

Said other registration may comprise a new registration of an identifier of the user or a re-registration of an identifier of the user.

The system may be provided with storage means for storing subscriber information and providing the control entities with such information. An expiry time of a registration of the user and/or information associated with the status of a registration of the user may also be stored at the storage entity. An expiration timer for a registration of the user may be run at the storage entity. The value of the timer may be provided with a registration identifier of the user to said second control entity.

The second control entity may provide a timer function for the at least one the transferred registration. A default value may be set for an expiry timer for at least one transferred registration.

### BRIEF DESCRIPTION OF DRAWINGS

For better understanding of the present invention, reference will now be made by way of example to the accompanying drawings in which:

FIG. 1 shows a communication system architecture wherein the present invention can be embodied;

FIG. 2 shows an embodiment; and

FIG. 3 shows information flows in accordance with an embodiment of the present invention.

### DESCRIPTION OF PREFERRED EMBODIMENTS OF THE INVENTION

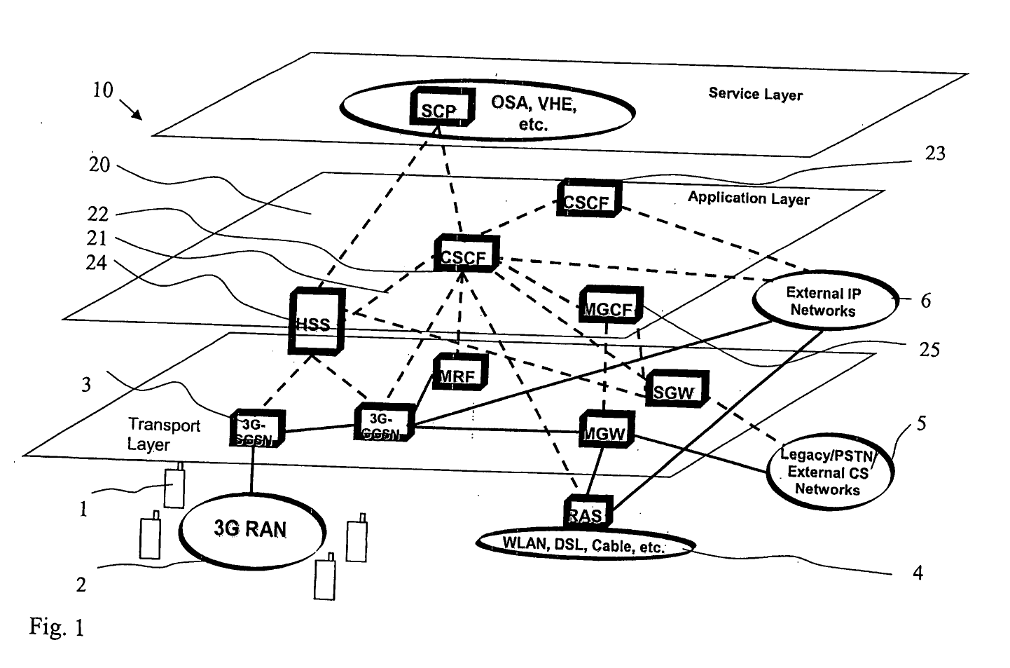

Reference is first made to FIG. 1 which shows a possible network architecture wherein the present invention may be embodied. The exemplifying network system 10 is arranged in accordance with UMTS 3G specifications. The cellular system 10 is divided between a radio access network (RAN) 2 and a core network (CN).

In general terms, it is possible to describe a communication system as a model in which the functions of the system are divided in several hierarchically arranged function layers. FIG. 1 shows three different function layers, i.e. a service layer, an application layer and a transport layer and the positioning of various network elements relative to these layers. It shall be appreciated that the layered model is shown only in order to illustrate the relationships between the various functions of a data communication system. In a physical i.e. real implementation the entities (e.g. servers or other nodes) are typically not arranged in a layered manner.

A plurality of user equipment 1 is served by a 3G radio access network (RAN) 2 over a wireless interface. The user equipment is enabled to move relative to the access entity, and may thus be referred to by the term mobile station. The radio access network function is hierarchically located on the transport layer. It shall be appreciated that although FIG. 1 shows only one radio access network for clarity reasons, a typical communication network system comprises a number of radio access networks.

The 3G radio access network (RAN) 2 is shown to be physically connected to a serving general packet radio service support node (SGSN) entity 3. The SGSN 3 is a part of the core network. In the functional model the entity 3 belongs to the transport layer. The operation of a typical cellular network and the various transport level entities thereof is known by the skilled person and will thus not be explained in more detail herein.

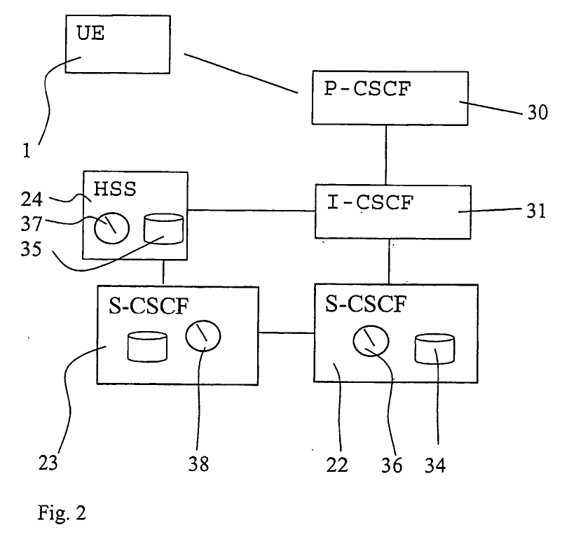

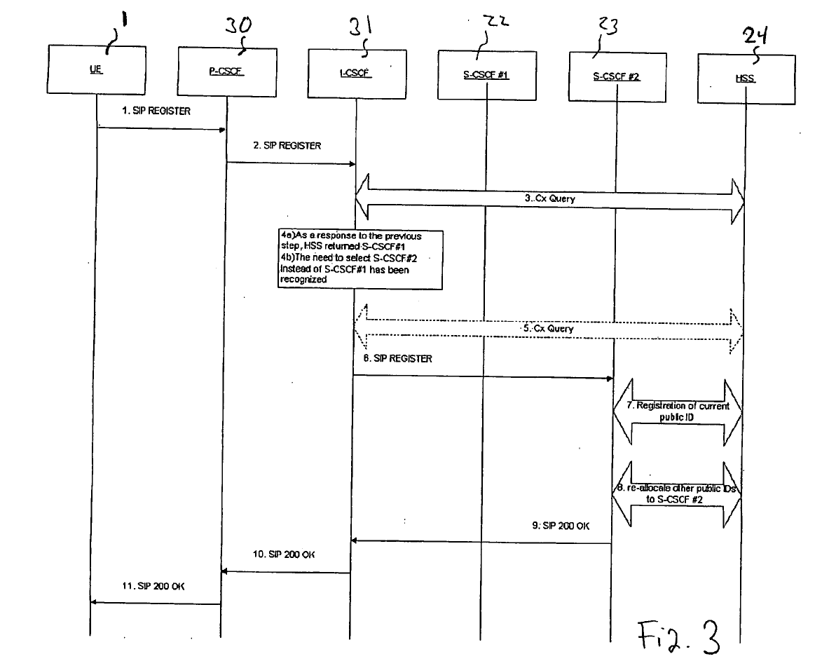

An application layer 20 is shown to be located on top of the transport layer. The application layer 20 may include several application level functions. FIG. 1 shows two call state control entities (CSCFs) 22 and 23. From these the call state server 22 is the so called serving call state control function (S-CSCF) wherein the user equipment 1 is registered to. That is, the server 22 is currently serving said user equipment 1 and is in control of the status of said user equipment. A procedure for transferring the registrations to the controller entity 23 is described later with reference to FIGS. 2 and 3.

The application layer is also shown to comprise a home subscriber server (HSS) entity 24. The home subscriber server (HSS) 24 is for storing data such as the registration identifiers (ID), their status (currently-registered-with-S-CSCF1 or currently-not-registered) and similar user related information.

For the sake of completeness some other elements such as various gateway entities (e.g. the Media Gateway Control Function MGCF, Media Gateway MGW and the Signalling Gateway SGW) are also shown. However, these do not form an essential part of the invention and will thus not be described in more detail.

The solid lines indicate actual data communication between various entities. The dashed lines indicate signalling traffic between various entities. The signalling is typically required for management and/or control functions, such as for registration, session set-up, charging and so on. As can be seen, user equipment 1 may have communication via the access network 2 and appropriate gateways with various other networks such as networks 4, 5 and 6. The other networks may be adapted to operate in accordance with the same standard as the network 10 or any other appropriate standard.

FIG. 2 shows in more detail the old and the new controller entities 22 and 23, respectively. Further controller entities such as a proxy CSCF 30 and an interrogating CSCF 31 are also shown. The functions of the various elements of FIG. 2 will described below with reference also to the signalling flow chart of FIG. 3.

In the shown embodiment individual public identifier (ID) registrations for a subscriber are synchronised in a 3GPP IMS domain. The relocation of a registered ID from an “old” controller entity 22 triggers transfer of other valid registrations of individual public IDs belonging to the same IMS subscriber to another, new controller entity 23. That is, all registered public IDs are transferred from the old S-CSCF to the new S-CSCF whenever a new ID is registered to a new S-CSCF or an already registered ID is moved to a new S-CSCF during re-registration procedure.

This transfer of identities be implemented, for example, by moving one public ID registration or a list of public ID registrations from one S-CSCF to another S-CSCF. This move may happen e.g. on a Cx interface between the HSS and the newly selected S-CSCF. The information may be transferred within a transaction regardless of the number of transferable identifiers. It is also possible to transfer the information by means of any arbitrary number of transactions. It shall thus be appreciated that arrows in FIG. 3 may represent a group of transactions instead of a single transaction.

More particularly, in FIG. 3 the user equipment 1 request for registration 1 by sending a SIP REGISTER message (1.) to a proxy server entity 30. The registration request is forwarded (2.) to an interrogating server entity 31. An appropriate query procedure (3.) may then be accomplished between the interrogating server entity 31 and the subscriber information database HSS 24.

During the query procedure the HSS 24 may recognise that this specific subscriber i.e. user has already some other public IDs registered to the network, and more specifically registered with the first control entity 22 (S-CSCF#1). Thus the HSS 24 may return as a response to the Cx query (step 3) a S-CSCF#1 (address/identity) to the I-CSCF 31.

According to a possibility the interrogating control entity (I-CSCF) 31 may recognise that the first control entity 22 (S-CSCF#1) is not the right entity where the new public ID of the user shall be registered at, or that the first control entity 22 (S-CSCF#1) may not be available. Thus the interrogating control entity 31 may select the second control entity 23 (S-CSCF#2) instead. From the point of view of the I-CSCF entity 31 it does not matter where the IDs of the user are registered to. Step 4 indicates an action where decisions are made in response top step 3. The decisions may be made based on the received information received and possibly some local decisions.

FIG. 3 shows also an optional Cx query (step 5). This may be done in case when the information received in step 3 has not been stored, or may have became invalid, or if the I-CSCF entity decides to ask for fresh information from the HSS.

The interrogating server may then request (6.) for registration from the second controller entity 23. At step (7.) the public identifier that associated with the request (1.) is registered at the second controller entity 23. Then at step (8.) other public identifiers are transferred to the second controller entity 23 and registered thereto. Acknowledgement messages (9. to 11.) may then be signalled in any appropriate manner.

At the time of registration of each public ID at the S-CSCF 22 the registration expiry time may be delivered to the HSS 24 and stored in storage means 35 thereof. The expiry time may stored in the HSS 24 in addition to storing the expiry time in the storage means 34 of the S-CSCF 22. Information such as separate registration status may also be stored in the HSS. This may be useful e.g. in occasions where the status cannot be calculated from the expiration time. This means that all changes in the expiration time and/or in the status may be maintained in the home subscriber server (HSS) on per public ID level.

Last registration path information for a specified user overrides the path information of previous registration for the same user in the P-CSCF 30. This may have been stored during the registration procedure using e.g. the so called path header.

A timer function 37 may also be provided in the HSS 24. The value of the timer 37 may be transferred together with the ID. Maintaining the timer in the HSS has some benefits. For example, calls can be delivered without being first sent to an already expired S-CSCF.

Provision of the expiration timer in the HSS may also be used for solving a problem that associates with the late recognition of registration expiration. More particularly, if the expiration time is maintained only by the timer function of a given S-CSCF, the HSS knows only the identity of the S-CSCF but not the expiry time.

On the other hand, the I-CSCF 31 may perform a location query to the HSS 24 and receive the S-CSCF identity in response for a call. Based on this the call is then forwarded to the S-CSCF 22. When the call is received at the S-CSCF, the subscriber data is checked. It may turn out only at this stage that the registration timer 36 of the entity 22 has already expired. This late recognition of the registration expiry may lead to some problems. The expiration time of the public IDs in the HSS may make the prevention of late recognition of registration expiry more effective. Thus the associated problems may be avoided by the provision of the timer function also in the HSS.

It shall be appreciated that the HSS timer is not required in all embodiments. It is, for example, possible the new S-CSCF 23 may set a default timer. A watch-dog function may also be provided in a S-CSCF.

If registration to multiple S-CSCFs is possible then only those public IDs that belong to the same “old” S-CSCF of the currently registered one may be synchronised to the new S-CSCF for that public ID. That is, in applications where different public IDs of a subscriber may be registered to different S-CSCFs groups of IDs can be moved between S-CSCFs in a similar manner as described above. The public IDs may be grouped into certain groups. One group of IDs may be registered to a specific S-CSCF e.g. based on some serving capabilities or some other feature.

These registrations will be handled by a common S-CSCF after the synchronisation.

This mechanism may be used to ensure that registrations of all public IDs belonging to same user are synchronised. The proposed mechanism may ensure that all public IDs belonging to the same subscriber or same registration group are registered to the same new S-CSCF 23 for example after a failure of the old S-CSCF 22. The transfer of the public IDs may be accomplished before the expiry of the timer at the S-CSCF of each such registration.

The above described a case where at least one registration was relocated to another controller entity and this triggered the relocation of the other registrations. The following is a description of other possible situation wherein the embodiments may provide advantage.

The example relates to situation when a subscriber decides to register e.g. its #5 public ID with the network. The first four public IDs may already be registered with the network, and more specifically, with a first controller entity S-CSCF1 of the network. When a I-CSCF entity ask the S-CSCF1 to accept the registration of the public ID #5, the S-CSCF1 may not respond. The reason may be a temporary failure, a temporary congestion, out of service, and so on. In such situation the I-CSCF is forced to select a new controller entity S-CSCF2. The ID#5 will then be registered to the S-CSCF2, while the four other IDs are still registered to the S-CSCF1. This may not be allowed in all communication systems.

Thus, when the ID#5 is registered with the S-CSCF2 the HSS or other database which is aware of the subscriber IDs and the S-CSCF entities to which the IDs are registered to will realise that the other IDs of the same subscriber are still registered to another S-CSCF. The HSS may then be forced to decide whether all previously registered public IDs shall be moved to the newly selected S-CSCF2 or not.

When the public IDs are moved to the selected new S-CSCF entity, then the expiration timer for the previously registered IDs should also be moved. However, the expiration timer may not be available in the HSS entity but only in the S-CSCF1 entity. The S-CSCF1 entity may not be accessible (e.g. due to failure) and thus the timer value may not always be available. When the timer value is not accessible, a default value may be set in the newly selected S-CSCF2 for each ID.

If the HSS function can access the S-CSCF1 entity and find out the exact values of the timers at that given time these values may then be transferred to the new S-CSCF2, e.g. on the so called Cx interface between the I-CSCFs and the HSS and the S-CSCFs and the HSS. If the timer value is available in the HSS, the value may be transferred to S-CSCF2 at the same time when the public ID registrations are transferred.

It should be appreciated that whilst embodiments of the present invention have been described in relation to user equipment such as mobile stations, embodiments of the present invention are applicable to any other suitable type of users.

The embodiments of the invention were discussed with reference to call state control function entities. Embodiments of the present invention can be applicable to other network elements where applicable.

The embodiment of the present invention has been described in the context of the Universal Mobile Telecommunication System (UMTS) 3G system and session initiation protocol (SIP). This invention is also applicable to any other communication systems and protocols. Examples of other systems, without limiting to these, include the General Packet Radio Service (GPRS), the Enhanced Data rate for GSM Evolution (EDGE) mobile data network, other third generation (3G) telecommunication systems such as the i-phone or IMT-2000 (International Mobile Telecommunications) and the Terrestrial Trunked Radio (TETRA) system.

It is also noted herein that while the above describes exemplifying embodiments of the invention, there are several variations and modifications which may be made to the disclosed solution without departing from the scope of the present invention as defined in the appended claims.

1. A method in a communication system wherein a user is provided with at least one registration to a first control entity, comprising transferring said at least one registration to a second control entity in response to another registration of the user to said second control entity.

2. A method as claimed in claim 1, wherein all registrations of the user in the first control entity are transferred to said second control entity.

3. A method as claimed in claim 1 or 2, wherein said other registration comprises a new registration of an identifier of the user.

4. A method as claimed in claim 1 or 2, wherein said other registration comprises a re-registration of an identifier of the user.

5. A method as claimed in any preceding claim, wherein the first and second control entities each provide call state control function.

6. A method as claimed in any preceding claim, wherein each of said registrations comprises a registration of a user identifier.

7. A method as claimed in claim 6, wherein the user identifier comprises a public identifier.

8. A method as claimed in any preceding claim, comprising signalling of information between at least one of the control entities and a storage entity adapted for storing information that associates with the user.

9. A method as claimed in claim 8, wherein the storage entity comprises a home subscriber server.

10. A method as claimed in claim 8 or 9, wherein the storage entity provides at least a part of the control function that associates with registrations that are provided for the user.

11. A method as claimed in any of claims 8 to 10, wherein the storage entity reallocates said at least one registration to the second control entity subsequent to provision of the user with said one other registration to said second control entity.

12. A method as claimed in any of claims 8 to 11, wherein an expiry time of a registration of the user is stored at the storage entity.

13. A method as claimed in any of claims 8 to 12, wherein information associated with the status of a registration of the user is stored at the storage entity.

14. A method as claimed in any of claims 8 to 13, wherein an expiration timer for a registration of the user is run at the storage entity.

15. A method as claimed in claim 14, wherein the value of the timer is provided with a registration identifier of the user to said second control entity.

16. A method as claimed in any preceding claim, wherein the second control entity runs a timer for at least one transferred registration.

17. A method as claimed in claim 16, wherein the second control entity sets the value for the timer.

18. A method as claimed in claim 16, wherein the value of the timer is provided by another entity.

19. A method as claimed in any preceding claim, comprising the step of recognising that the user has at least one registration at the second control entity.

20. A method as claimed in any preceding claim, wherein only predefined registrations of the user are transferred to said second control entity.

21. A communication system comprising a first control entity and a second control entity, wherein at least one registration of the user at the first entity is adapted to be transferred to the second control entity in response to a registration of the user at said second control entity.

22. A communication system as claimed in claim 21, wherein the system is arranged to transfer all registrations the user has with the first control to the second control entity.

23. A communication system as claimed in any of claims 21 or 22, wherein the first and second control entities each provide a call state control function.

24. A communication system method as claimed in any of claims 21 to 23, wherein each of said registrations comprises a registration of a user identifier.

25. A communication system as claimed in any of claims 21 to 24, comprising a storage entity for storing user data and adapted for communication with at least one of the control entities.

26. A communication system as claimed in claim 25, wherein the storage entity comprises a home subscriber server.

27. A communication system as claimed in claim 25 or 26, wherein the storage entity provides at least a part of the control function that associates with registrations that are provided for the user.

28. A communication system as claimed in any of claims 25 to 27, wherein the storage entity of provided with a registration expiry timer.

29. A communication system as claimed in any of claims 21 to 28, wherein the user comprises a mobile user equipment.

30. A communication system as claimed in claim 29, further comprising an intermediate server entity located between said control entities and the mobile user equipment.
